(19) United States
(12) Patent Application Publication
(10) Pub. No.: US 2026/0293851 A1
(43) Pub. Date: Oct. 1, 2026

(54) UNDERWEAR-TYPE DISPOSABLE DIAPER FOR PET

(71) Applicant: Unicharm Corporation, Shikokuchuo-shi, Ehime (JP)

(72) Inventor: Daisuke KOMATSUBARA, Kanonji-shi, Kagawa (JP)

(21) Appl. No.: 19/483,134

(22) PCT Filed: May 28, 2024
(86) PCT No.: PCT/JP2024/019495

§ 371 Date: Nov. 10, 2025

(30) Foreign Application Priority Data
May 31, 2023 (JP) 2023-090264

(51) Int. Cl. A01K 23/00

(52) U.S. Cl. CPC A01K 23/00

(57) ABSTRACT

An underwear-type disposable diaper (1) for a pet comprises an absorbent body (10) provided with an absorbent core (12), an abdominal-side waist part (20), and a back-side waist part (30), the abdominal-side waist part (20) and the back-side waist part (30) being joined by a pair of side joining parts (40) at both side parts in a lateral direction, wherein: a tail insertion section (50) through which a tail can be inserted is provided below the pair of side joining parts (40) in a vertical direction; and a pair of inclined elastic members (8a, 8b) having inclined parts (801a, 801b) extending obliquely downward toward the lower side in the vertical direction and inward in the lateral direction are disposed on at least one of the abdominal-side waist part (20) and the back-side waist part (20) at the lower side in the vertical direction and at both side parts in the lateral direction relative to the pair of side joining parts (40).

### FIELD

The present disclosure relates to an underpants-shaped disposable pet diaper.

### BACKGROUND

Diapers for pets such as dogs and cats are known. For example, PTL 1 discloses an underpants-shaped disposable pet diaper including a waist region, a crotch region, a waist opening, a pair of leg openings, an absorbent core, and a tail insertion opening. In such an underpants-shaped disposable pet diaper, a plurality of waist stretchable elastic members are arranged in the waist region.

### CITATION LIST

### Patent Literature

[PTL 1] Japanese Patent Application Publication No. 2014-226110

### SUMMARY

### Technical Problem

In the underpants-shaped disposable pet diaper of PTL 1, the waist region includes a region with low stretching stress, thereby preventing excessive tightening of the pet's waist to improve the fit around the pet's waist. However, when underpants-shaped diapers are put on pets such as dogs and cats, in most cases, it is difficult to put the diaper on a moving pet at an appropriate position while holding the pet. Specifically, for the underpants-shaped diapers, the pet's hind legs are first passed through the leg openings and the pet's tail is then passed through the tail insertion portion. Finally, the diaper is pulled up. At this time, the diaper needs to be pulled up to the base of the tail. However, in some cases, the diaper cannot be pulled up properly to the base, which makes it difficult for the tail to fit to the tail insertion portion.

The present invention was achieved in light of conventional problems such as that described above, an aspect of the present invention is to provide an underpants-shaped disposable pet diaper that improves the ability to pull up the diaper at the time of wearing.

### Solution to Problem

A main aspect of the present disclosure for achieving the above-described aspect is an underpants-shaped disposable pet diaper having a vertical direction and a lateral direction that intersect with each other, the underpants-shaped disposable pet diaper including: an absorbent main body including an absorbent core; a ventral waist portion; and a dorsal waist portion, two lateral side portions of the ventral waist portion and two lateral side portions of the dorsal waist portion being joined by a pair of side-joining portions, a tail insertion portion through which a tail is passed being provided below the pair of side-joining portions in the vertical direction, at least one of the ventral waist portion and the dorsal waist portion including a pair of inclined elastic members, the pair of inclined elastic members each having an inclined portion, the inclined portion being located below the pair of side-joining portions in the vertical direction and at two lateral side portions, the inclined portion extending inward in the lateral direction and diagonally downward in the vertical direction.

Features of the present disclosure other than the above will become clear by reading the description of the present specification with reference to the accompanying drawings.

### Advantageous Effect of the Invention

The present invention can provide an underpants-shaped disposable pet diaper that improves the ability to pull up the diaper at the time of wearing.

### BRIEF DESCRIPTION OF DRAWINGS

FIG. 1 is a schematic perspective view of an underpants-shaped disposable pet diaper 1 according to a first embodiment, as viewed from a dorsal side.

FIG. 2 is a schematic plan view of the diaper 1 according to the first embodiment, in an unfolded and stretched state as viewed from a skin side.

FIG. 3 is a schematic cross-sectional view taken along a line A-A in FIG. 2.

FIG. 4 is a schematic plan view of the diaper 1 according to the first embodiment, in an unfolded and stretched state as viewed from a non-skin side.

FIGS. 5A to 5C are illustrative views of operations for putting on the diaper 1.

FIG. 6 is a plan view of an area AR1 and an area AR2 in the diaper 1.

FIG. 7 illustrates a modification of the first embodiment.

FIG. 8 illustrates a modification of the arrangement of a tail insertion portion 50.

FIG. 9 is a schematic plan view of a diaper 1 according to a second embodiment, in an unfolded and stretched state as viewed from a skin side.

### DESCRIPTION OF EMBODIMENTS

At least the following matters will become clear with the description of this specification and the attached drawings. Aspect 1 is an underpants-shaped disposable pet diaper having a vertical direction and a lateral direction that disposable pet diaper including: an absorbent main body including an absorbent core; a ventral waist portion; and a dorsal waist portion, two lateral side portions of the ventral waist portion and two lateral side portions of the dorsal waist portion being joined by a pair of side-joining portions, a tail insertion portion through which a tail is passed being provided below the pair of side-joining portions in the vertical direction, at least one of the ventral waist portion and the dorsal waist portion including a pair of inclined elastic members, the pair of inclined elastic members each having an inclined portion, the inclined portion being located below the pair of side-joining portions in the vertical direction and at two lateral side portions, the inclined portion extending inward in the lateral direction and diagonally downward in the vertical direction.

According to Aspect 1, in the case where the inclined elastic members are arranged in the ventral waist portion, the pull-up force is more likely to be transmitted to the absorbent main body on the ventral side when the tail is passed through the tail insertion portion and the diaper is finally pulled up. This can improve the fit on the ventral side. In the case where the inclined elastic members are arranged in the dorsal waist portion, the pull-up force is more easily applied on the two lateral sides Of the tail insertion portion when the tail is passed through the tail insertion portion and the diaper is finally pulled up. Thus, the inclined elastic members work together to pull up the tail insertion portion, thereby easily pulling up the diaper further to the base of the tail.

Aspect 2 is the underpants-shaped disposable pet diaper according to Aspect 1, wherein, in an unfolded and stretched state, an area of the underpants-shaped disposable pet diaper from a longitudinal central position of the underpants-shaped disposable pet diaper to a longitudinal inward end of the side-joining portion of the ventral waist portion is smaller than an area of the underpants-shaped disposable pet diaper from the longitudinal central position to a longitudinal inward end of the side-joining portion of the dorsal waist portion.

According to Aspect 2, the area from the longitudinal central position of the diaper to the inward end (lower end) of the side-joining portion of the ventral waist portion is smaller. Thus, the pet's legs are less likely to get caught at the time of wearing of the diaper, which can reduce interference with movement of the legs even after the diaper is put on.

Aspect 3 is the underpants-shaped disposable pet diaper according to Aspect 1 or 2, wherein, the pair of inclined elastic members is arranged in the ventral waist portion and the dorsal waist portion, respectively, the inclined elastic member of the ventral waist portion refers to a ventral inclined elastic member, the inclined elastic member of the dorsal waist portion refers to a dorsal inclined elastic member, and, in the vertical direction, a length of the inclined portion of the dorsal inclined elastic member is longer than a length of the inclined portion of the ventral inclined elastic member.

According to Aspect 3, the vertical length of the inclined portion of each dorsal inclined elastic member is long, the pull-up force can be transmitted farther along the direction in which the dorsal inclined elastic members extend, that is, can be transmitted to the crotch side, when the pet's tail is passed through the tail insertion portion to pull up the dorsal waist portion.

Aspect 4 is the underpants-shaped disposable pet diaper according to any one of Aspects 1 to 3, wherein, the pair of inclined elastic members is arranged in the dorsal waist portion, and, the pair of inclined elastic members is arranged to span a longitudinal central position of the underpants-shaped disposable pet diaper in an unfolded and stretched state.

According to Aspect 4, since the dorsal inclined elastic members span the longitudinal central position, that is, since the dorsal inclined elastic members extend to the ventral side, the pull-up force is more easily transmitted to the ventral side when the diaper is pulled up with the tail passed through the tail insertion portion. This improves the fit on the ventral side.

Aspect 5 is the underpants-shaped disposable pet diaper according to any one of Aspects 1 to 4, wherein, the pair of inclined elastic members is arranged in the dorsal waist portion, and, in the vertical direction, a lower end of each of the inclined elastic members is located below an upper end of the tail insertion portion.

According to Aspect 5, the inclined elastic members are located in such a position, the inclined elastic members work in conjunction to pull up the tail insertion portion when the diaper is pulled up with the tail passed through the tail insertion portion. This facilitates a better fit of the tail.

Aspect 6 is the underpants-shaped disposable pet diaper according to any one of Aspects 1 to 5, wherein, the pair of inclined elastic members is arranged in the dorsal waist portion, and, in the vertical direction, a lower end of the inclined elastic member is located below a lower end of the tail insertion portion.

According to Aspect 6, the inclined elastic members are located in such a position, the inclined elastic members work in conjunction to more easily pull up the tail insertion portion when the diaper is pulled up with the tail passed through the tail insertion portion. This facilitates a better fit of the tail.

Aspect 7 is the underpants-shaped disposable pet diaper according to any one of Aspects 1 to 6, wherein, the pair of inclined elastic members is arranged in the dorsal waist portion, the dorsal waist portion includes a non-stretchy region between a pair of the inclined portions of the pair of inclined elastic members, the non-stretchy region being a region where the inclined elastic members are not capable of stretching and contracting in the lateral direction, and, the tail insertion portion and the non-stretchy region have an overlapping portion in the lateral direction.

According to Aspect 7, the non-stretchy region is the region where stretchability in the lateral direction is not exhibited. Thus, the overlapping portion where such a non-stretchy region and the tail insertion portion overlap in the lateral direction can prevent the tail insertion portion from deforming due to lateral contraction.

Aspect 8 is the underpants-shaped disposable pet diaper according to any one of Aspects 1 to 6, wherein, the pair of inclined elastic members is arranged in the dorsal waist portion, the pair of inclined elastic members has a straight portion that is located along the lateral direction and between a pair of the inclined portions, the straight portion has a discontinuous portion in which the inclined elastic members are discontinuous by being cut from a non-skin-side surface, the absorbent core does not exist in a region overlapping the tail insertion portion in a thickness direction of the underpants-shaped disposable pet diaper, and the tail insertion portion and the discontinuous portion do not overlap as viewed in the thickness direction.

According to Aspect 8, the discontinuous portion of the inclined elastic members is the portion where the inclined elastic members are cut from the non-skin-side surface of the diaper, and at the time of cutting of the inclined elastic members in the state where the discontinuous portion and the tail insertion portion overlap, sheet members that constitute the tail insertion portion may also be cut together, which may cause leakage from the tail insertion portion. Then, the tail insertion portion and the discontinuous portion do not overlap as viewed in the thickness direction, which can avoid such leakage.

Aspect 9 is the underpants-shaped disposable pet diaper according to Aspect 8, wherein, the pair of inclined elastic members is arranged to span a longitudinal central position of the underpants-shaped disposable pet diaper in an unfolded and stretched state.

According to Aspect 9, since the dorsal inclined elastic members span the longitudinal central position, that is, since the dorsal inclined elastic members extend to the ventral side, the pull-up force is more easily transmitted to the ventral side when the diaper is pulled up with the tail passed through the tail insertion portion. This improves the fit on the ventral side. In addition, the tail insertion portion is located in the dorsal waist portion. Then, due to the contractive force of the inclined elastic members extending beyond the tail insertion portion further to the ventral side, the whole of the dorsal inclined elastic members works in conjunction to more easily pull up the tail insertion portion when the diaper is pulled up.

Aspect 10 is the underpants-shaped disposable pet diaper according to any one of Aspects 1 to 4 and 7 to 9, wherein, the pair of inclined elastic members is arranged in the dorsal waist portion, and in the vertical direction, a central position of the tail insertion portion is located below a central position of the inclined portion.

According to Aspect 10, the central position of the tail insertion portion in the vertical direction is located below the central position of the inclined portion in the vertical direction, thereby making the pull-up force of the dorsal inclined elastic members more likely to be applied to the tail insertion portion located on the lower side when the dorsal inclined elastic members contract at the time of wearing the diaper. As a result, the tail insertion portion is more easily pulled up to the base of the tail.

### First Embodiment

Hereinafter, an underpants-shaped disposable pet diaper according to a first embodiment of the present disclosure will be described with reference to the drawings.

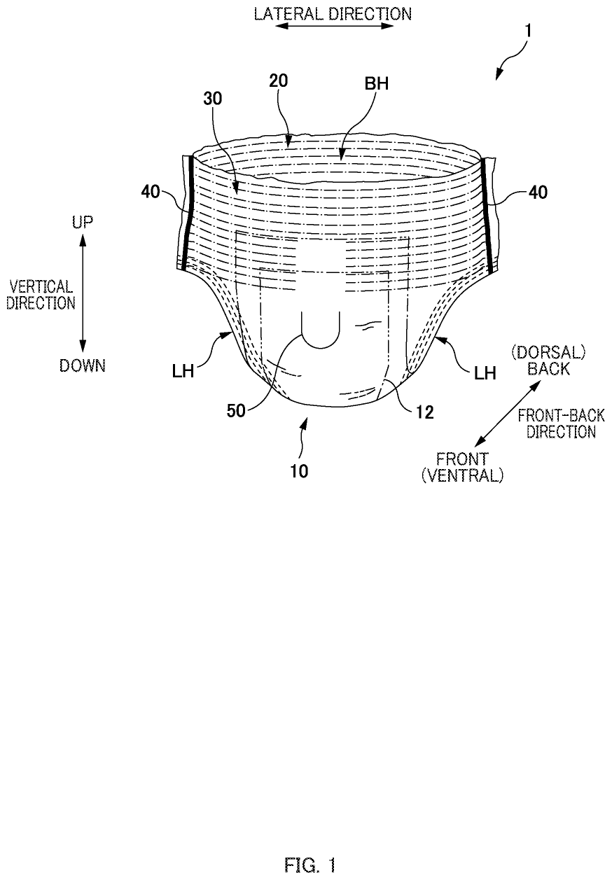

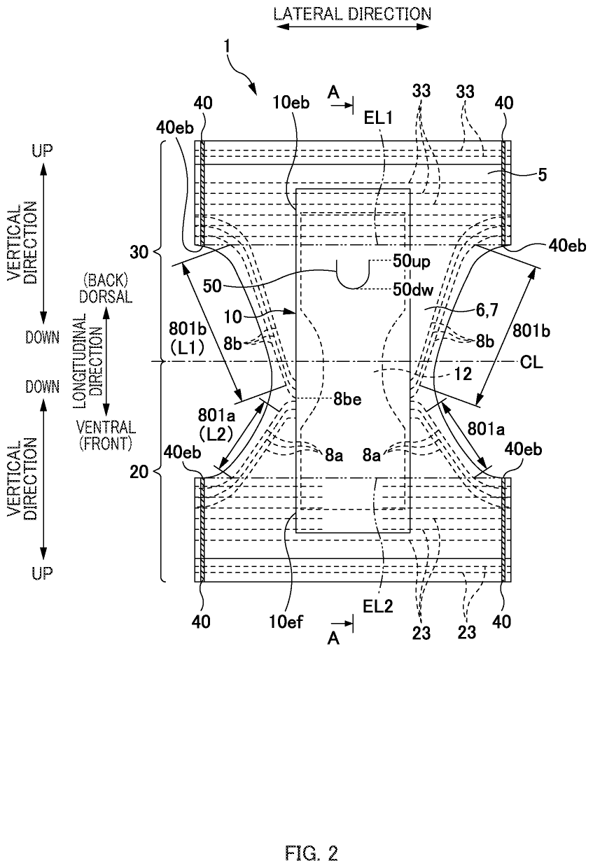

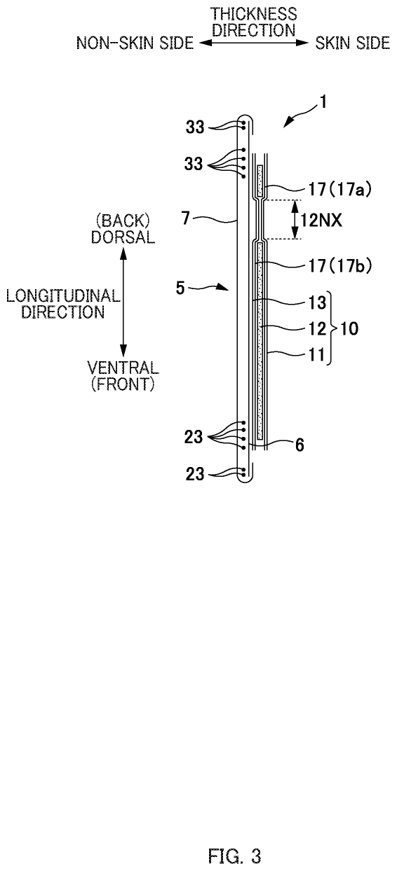

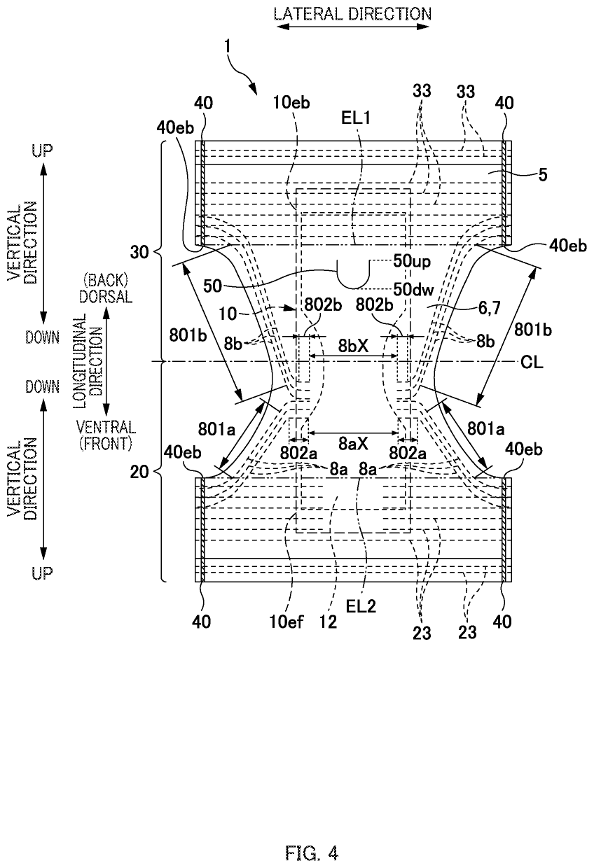

FIG. 1 is a schematic perspective view of an underpants-shaped disposable pet diaper 1 (hereinafter, also referred to as a “diaper 1”) according to a first embodiment, as viewed from the dorsal side. FIG. 2 is a schematic plan view of the diaper 1 according to the first embodiment, in the unfolded and stretched state as viewed from the skin side. FIG. 3 is a schematic cross-sectional view taken along a line A-A in FIG. 2. FIG. 4 is a schematic plan view of the diaper 1 according to the first embodiment, in an unfolded and stretched state as viewed from a non-skin side.

The underpants-shaped disposable pet diaper 1 is a diaper for pets. In the present specification, the term “pets” broadly include vertebrates and invertebrates, and typically include domestic pets such as dogs, cats, rabbits, and hamsters.

The unfolded state of the diaper 1 is a state in which a pair of side-joining portions 40 provided on both side portions of the diaper 1 is separated apart and the diaper 1 is unfolded flat. The stretched state of the diaper 1 is a state in which elastic members of the diaper 1 are stretched to the extent that wrinkles formed in the diaper 1 are substantially no longer visible. Specifically, it is a state in which the diaper 1 is stretched such that the lengths of the constituent members thereof match or are close to the dimensions of the members on their own (i.e., the dimensions in a state where the stretchability of the elastic members is not exhibited).

The diaper 1 in the underpants-shaped state shown in FIG. 1 has a vertical direction, a lateral direction, and a front-back direction, and includes a waist opening BH and a pair of leg openings LH. In the vertical direction, the waist side corresponds to the upper side, and the crotch side corresponds to the lower side. In the front-back direction, the front side corresponds to the ventral side of a pet, and the back side corresponds to the dorsal side of the pet. The lateral direction is a direction conforming to the pet's waist. As shown in FIG. 3, the direction in which the constituent members of the diaper 1 are overlaid on each other is referred to as a thickness direction. In the thickness direction, the side that faces a skin surface of the pet during usage of the diaper 1 is referred to as the skin side, and the opposite side is referred to as the non-skin side. In addition, when the diaper 1 is in the unfolded state as shown in FIG. 2, the diaper 1 has the longitudinal direction, the lateral direction, and the thickness direction (in FIG. 2, a direction passing through the paper plane) that intersect with each other. The longitudinal direction is a direction that conforms to the vertical direction and also connects the pet's ventral side to dorsal side. That is, a longitudinal one side of the diaper 1 corresponds to the front side in the front-back direction, and a longitudinal other side of the diaper 1 corresponds to the back side in the front-back direction. The lateral direction conforms to that of the diaper 1 in the underpants-shaped state shown in FIG. 1.

The diaper 1 includes an exterior body 5 and a liquid-absorbent absorbent main body 10. The exterior body 5 is joined onto the non-skin side of the absorbent main body 10. The exterior body 5 of the diaper 1 is integrally formed so as to be continuous in the longitudinal direction of the absorbent main body 10, as shown in FIGS. 2 and 3. That is, the diaper 1 including two members: the absorbent main body 10; and the exterior body 5, is a so-called two-piece type of diaper. The exterior body 5 includes: a ventral waist portion 20 located on the front side with respect to a longitudinal central position CL; and a dorsal waist portion 30 located on the back side with respect to the longitudinal central position CL.

As shown in FIGS. 2 and 3, a longitudinal-one-end side of the absorbent main body 10 (an end portion 10ef) is joined to the ventral waist portion 20. The ventral waist portion 20 is a portion located on the ventral side of the pet when the diaper 1 is put on the pet. A longitudinal-other-end side of the absorbent main body 10 (an end portion 10eb) is joined to the dorsal waist portion 30. The dorsal waist portion 30 is a portion located on the dorsal side of the pet when the diaper 1 is put on the pet.

When the diaper 1 in the unfolded state shown in FIG. 2 is formed into an underpants-shaped diaper, the absorbent main body 10 and the exterior body 5 are folded one time at the longitudinal central position CL serving as a fold position such that the ventral waist portion 20 and the dorsal waist portion 30 face each other. In this folded state, two lateral side portions of the ventral waist portion 20 and two lateral side portions of the dorsal waist portion 30 are joined by welding (e.g., heat welding or ultrasonic welding) or the like, thereby forming the pair of side-joining portions 40. As a result, the diaper 1 in an underpants-shaped state is obtained.

The absorbent main body 10 includes: an absorbent core 12 that absorbs excrement ; a liquid-permeable top sheet 11 provided on the skin side with respect to the absorbent core 12; and a liquid-impermeable back sheet 13 provided on the non-skin side with respect to the absorbent core 12. They adhere with an adhesive or the like. However, the absorbent main body 10 may include sheet members other than the above members. For example, a second seat (not illustrated) may be provided between the top sheet 11 and the absorbent core 12 in the thickness direction.

Examples of the absorbent core 12 include an absorbent core obtained by shaping liquid-absorbent fibers, such as pulp fibers containing superabsorbent polymer, into predetermined shape. The absorbent core 12 may be covered with a core-wrapping sheet 17 such as liquid-permeable tissue paper, a nonwoven fabric, or the like. Other examples of the absorbent core 12 include an SAP sheet obtained by affixing an SAP layer to a hydrophilic sheet, an air-laid sheet in which liquid absorbent fibers are formed into a sheet by an air-laid method, and the like.

In addition, the absorbent main body 10 may include, on two lateral sides thereof, leakproof-wall portions (not illustrated). The leakproof-wall portions correspond to so-called barrier cuffs. When the diaper 1 is put on, the leakproof-wall portions rise toward the pet's skin side from the two lateral sides of the absorbent main body 10, thus suppressing the case where a liquid such as urine leaks from the absorbent main body 10.

The exterior body 5 includes a skin-side sheet 6 and a non-skin-side sheet 7 that is overlaid to be adjacent to the non-skin side of the skin-side sheet 6, as shown in FIG. 3. In the present embodiment, the skin-side sheet 6 and the non-skin-side sheet 7 can be made of, for example, spunbond nonwoven fabric, SMS nonwoven fabric (spunbond/meltblown/spunbond nonwoven fabric) , or the like. The longitudinal outer end of the non-skin-side sheet 7 is folded back toward the skin side. The folded-back portion of the non-skin-side sheet 7 wraps the longitudinal one end (outer end) of the skin-side sheet 6. The longitudinal outer end (upper end) of the non-skin side sheet 7 may be configured to not be folded back.

In the ventral waist portion 20 of the exterior body 5, a plurality of ventral elastic members 23 (such as elastic strings) that can stretch and contract in the lateral direction are provided side-by-side in the vertical direction. In the same manner, in the dorsal waist portion 30 of the exterior body 5, a plurality of dorsal elastic members 33 (such as elastic strings) that can stretch and contract in the lateral direction are provided side-by-side in the vertical direction with being stretched in the lateral direction. The ventral and dorsal elastic members 23 and 33 are each provided being sandwiched between the skin-side sheet 6 and the non-skin-side sheet 7 with being stretched in the lateral direction. The ventral and dorsal elastic members 23 and 33 respectively give stretchability in the lateral direction to the ventral waist portion 20 and the dorsal waist portion 30.

In the present embodiment, the ventral waist portion 20 and the dorsal waist portion 30 respectively include ventral inclined elastic members 8a and dorsal inclined elastic members 8b provided between the skin-side sheet 6 and the non-skin-side sheet 7, respectively. At least portions of the ventral inclined elastic members 8a and dorsal inclined elastic members 8b are arranged along the pair of leg openings LH, Examples of the ventral and dorsal inclined elastic members 8a and 8b include a plurality of elastic strings, a band-shaped elastic sheet having stretchability. The ventral and dorsal inclined elastic member 8a, 8b in the stretched state are joined and fixed with an adhesive such as hot-melt adhesive.

In the present embodiment, three ventral inclined elastic members 8a and three dorsal inclined elastic members 8b are arranged at intervals in a direction perpendicular to the stretch direction of the ventral and dorsal inclined elastic members 8a and 8b. However, the number of ventral and dorsal inclined elastic members 8a and 8b may be one or any plurality other than three, respectively, and at least one pair is simply required to be provided on the two lateral sides.

In the present embodiment, the ventral inclined elastic members 8a and the dorsal inclined elastic members 8b respectively include inclined portions 801a and 801b located below the pair of side-joining portions 40 in the vertical direction and at two lateral side portions. The inclined portions 801a and 801b extend inward in the lateral direction and diagonally downward in the vertical direction. Specifically, as shown in FIG. 2, the ventral inclined elastic members 8a have the inclined portions 801a, 801a that are located below a line EL2 and on the two lateral sides, The inclined portions 801a, 801a extend inward in the lateral direction and diagonally downward in the vertical direction. The line EL2 connects, in the ventral waist portion 20, a lower end 40eb of the side-joining portion 40 on the left side in the lateral direction and a lower end 40eb of the side-joining portion 40 on the right side in the lateral direction. Similarly, the dorsal inclined elastic members 8b have the inclined portions 801b, 801b that are located below a line EL1 and on the two lateral sides. The inclined portions 801b, 801b extend inward in the lateral direction and diagonally downward in the vertical direction. The line EL1 connects, in the dorsal waist portion 30, a lower end 40eb of the side-joining portion 40 on the left side in the lateral direction and a lower end 40eb of the side-joining portion 40 on the right side in the lateral direction.

As shown in FIG. 4, the ventral inclined elastic members 8a of the present embodiment have straight portions 802a that are located along the lateral direction and between at least a pair of the inclined portions 801a, 801a. Similarly, the dorsal inclined elastic members 8b have straight portions 802b that are located along the lateral direction and between at least a pair of the inclined portions 801b, 801b. In the straight portions 802a, 802b, both the ventral inclined elastic members 8a and the dorsal inclined elastic members 8b in the stretched state in the lateral direction are joined and fixed between the skin-side sheet 6 and the non-skin-side sheet 7. The ventral inclined elastic members 8a and the dorsal inclined elastic members 8b need not include the straight portions 802a and 802b, respectively. The straight portions 802a and 802b may be, for example, curved portions that are curved inward in the lateral direction, as long as they facilitates stretching and contracting in the lateral direction.

The ventral waist portion 20 includes a non-stretchy region 8aX between the pair of inclined portions 801a, 801a of the inclined elastic members 8a, 8a that are provided at the two lateral side portions. The non-stretchy region 8aX is a region where the ventral inclined elastic members 8a cannot stretch and contract in the lateral direction. Similarly, the dorsal waist portion 30 includes a non-stretchy region 8bX between the pair of inclined portions 801b, 801b of the inclined elastic members 8b, 8b that are provided at the two lateral side portions. The non-stretchy region 8bX is a region where the dorsal inclined elastic members 8b cannot stretch and contract in the lateral direction. The arrangement of the non-stretchy regions 8aX and 8bX is not limited to the positions shown in FIG. 4. The non-stretchy regions 8aX and 8bX are simply required to be provided at least in a central portion of the diaper 1 in the lateral direction so as to suppress contraction of the absorbent core 12 in the lateral direction.

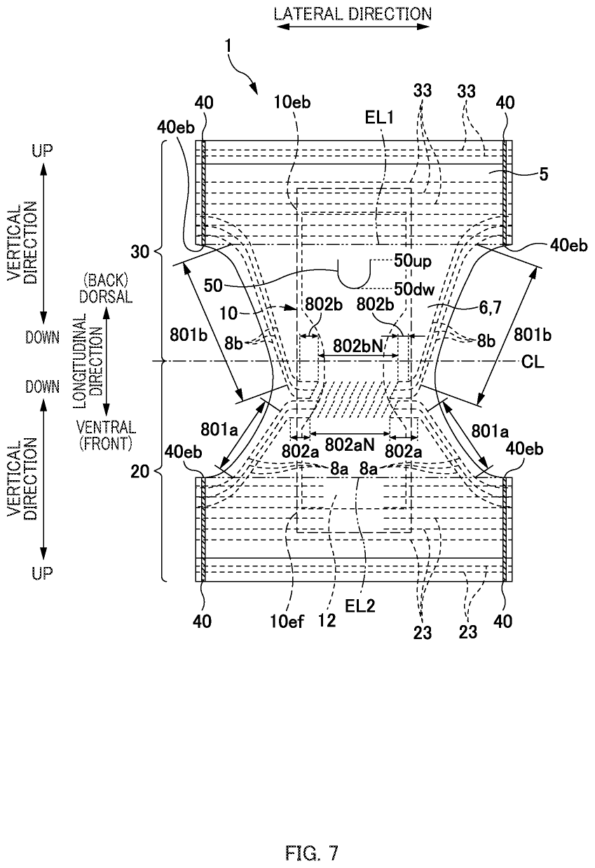

In the non-stretchy regions 8aX and 8bX, when the ventral inclined elastic members 8a and the dorsal inclined elastic members 8b are respectively arranged between the skin-side sheet 6 and the non-skin-side sheet 7, the ventral inclined elastic members 8a and the dorsal inclined elastic members 8b are not fixed with an adhesive, but the ventral inclined elastic members 8a and the dorsal inclined elastic members 8b are cut at the portions that become the non-stretchy regions 8aX and 8bX. As a result, the non-stretchy regions 8aX and 8bX do not stretch and contract in the lateral direction while stretchability of the straight portions 802a and 802b remains. The formation of the non-stretchy regions 8aX and 8bX is not limited thereto. For example, as shown in FIG. 7 described below, the ventral and dorsal inclined elastic members 8a, 8b can be formed as follow: the ventral and dorsal inclined elastic members 8a, 8b are fixed with an adhesive in portions that become the non-stretchy regions 8aX and 8bX, and stretchability is eliminated by cutting (that is, finely cutting) the ventral and dorsal inclined elastic members 8a, 8b at multiple positions in the portions that become the non-stretchy regions 8aX and 8bX, by means such as pressing.

The absorbent main body 10 includes the tail insertion portion 50 through which the pet's tail can be passed. The tail insertion portion 50 may be a cutout having a substantially U-shape, for example. The shape of the tail insertion portion 50 is not limited to the substantially U-shape, but may be a semicircular, rectangular, trapezoidal, polygonal or elliptical shape. When the tail insertion portion 50 is formed by cutting, the shape is not limited to the above-mentioned shapes. For example, the cutout may have a cross shape. The cutout of the tail insertion portion 50 may be a continuous cutout, or may be perforations, for example, configured to tear constituent sheet members (here, the top sheet 11, the core-wrapping sheet 17, the back sheet 13, the skin-side sheet 6, and the non-skin-side sheet 7) that form the cutout. An additional cutout for expanding the dimension of the tail insertion portion 50 may be provided. In addition, the tail insertion portion 50 is not limited to the cutout, but may be an opening through which the tail can be passed.

In the present embodiment, a region 12NX where the absorbent core 12 does not exist is provided extending in the longitudinal direction and outward in the lateral direction from the tail insertion portion 50 by a predetermined distance (see FIG. 3). That is, the tail insertion portion 50 is formed by the cutout in the region 12NX, which prevents the material constituting the absorbent core 12 from being exposed from the tail insertion portion 50.

The basic configuration of the diaper 1 has been described above, but the configuration of the diaper 1 is not limited to the above. For example, the ventral waist portion 20 and the dorsal waist portion 30 need not be formed by a single continuous member (exterior body 5), but the diaper 1 may be a so-called three-piece type of diaper in which the ventral waist portion 20 and the dorsal waist portion 30 are respectively formed as Separate members. The elastic members 23, 33 may be sheet-like elastic materials (such as stretchy film and stretchy nonwoven fabric) instead of the elastic strings.

### Operations for Putting on Underpants-Shaped Disposable Pet Diaper 1

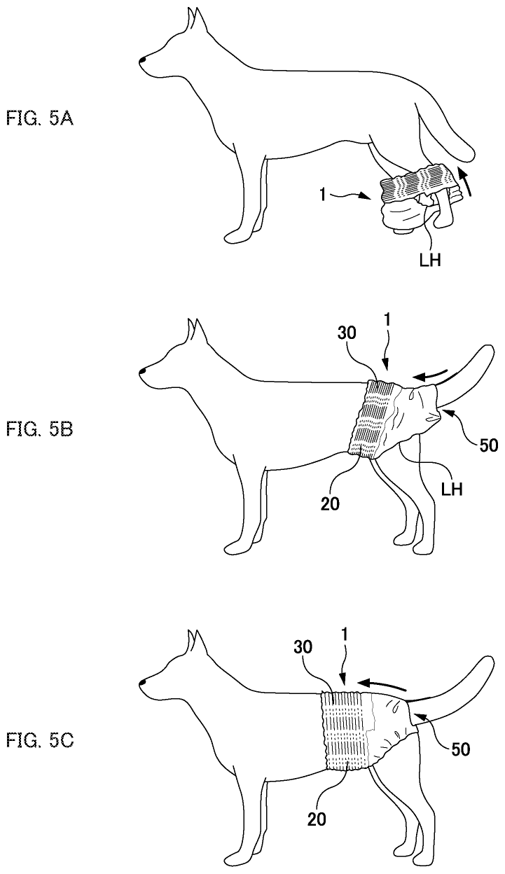

Next, the wearing operations when the diaper 1 is actually put on a pet will be described. FIGS. 5A to 5C are illustrative views of operations for putting on the diaper 1. FIGS. 5A to 5C illustrate that the pet wearing the diaper 1 is a dog. First, a diaper changer passes the pet's hind legs one by one through the leg openings LH while supporting the hind legs, as shown in FIG. 5A. After that, the diaper changer pulls the diaper 1 up to the vicinity of the pet's tail and passes the pet's tail through the tail insertion portion 50, as shown in FIG. 5B. Finally, as shown in FIG. 5C, the diaper changer pulls the diaper 1 diagonally upward and toward the front side of the pet's body. When the diaper 1 is pulled up, the diaper changer pulls up the diaper 1 while firmly holding the ventral waist portion 20 and the dorsal waist portion 30 with both hands, thereby fitting the diaper 1 around the pet's waist. At the same time, the tail insertion portion 50 is pulled up to the base of the tail, thereby achieving the fit of the pet's tail.

As described above, when the diaper changer puts the underpants-shaped disposable pet diaper 1 on a pet, the diaper changer first passes the pet's hind legs, then passes the tail through the tail insertion portion 50, and pulls up the diaper 1. When the diaper 1 is pulled up, the tail insertion portion 50 needs to be pulled up to the base of the tail; however, it cannot be successfully pulled up to the base, resulting in a poor fit of the tail to the tail insertion portion 50.

In this regard, in the diaper 1 of the present embodiment, as described above, the dorsal waist portion 30 includes the dorsal inclined elastic members 8b (inclined elastic members) having the inclined portions 801b provided at two lateral side portions and below the pair of side-joining portions 40 in the vertical direction. The ventral waist portion 20 also includes the ventral inclined elastic members 8a (inclined elastic members) having the inclined portions 801a provided at the two lateral side portions and below the pair of side-joining portions 40 in the vertical direction. The inclined portions 801b of the dorsal inclined elastic members 8b are arranged in the dorsal waist portion 30, which allows a force for pulling up the diaper 1 to be easily applied on the two lateral sides of the tail insertion portion 50 when the tail is passed through the tail insertion portion 50 and the diaper 1 is finally pulled up during wearing operation of the diaper 1 (in the state of FIG. 5C). At this time, the dorsal inclined elastic members 8b work in conjunction to pull up the tail insertion portion 50, thereby easily pulling up the tail insertion portion 50 further to the back (base) of the tail. Due to the inclined portions 801a of the ventral inclined elastic members 8a arranged in the ventral waist portion 20, the pull-up force is more likely to be transmitted to the absorbent main body 10 on the ventral side when the diaper 1 is pulled up at the end of wearing operation (in the state of FIG. 5C). This can improve the fit on the ventral side.

In the present embodiment, both the ventral inclined elastic members 8a and the dorsal inclined elastic members 8b respectively have three elastic members on the two lateral sides, but at least one pair (one on each side) of the inclined elastic members (8a, 8b) is simply required to be arranged. In this case, the same effect as described above can be achieved. In the present embodiment, both the ventral waist portion 20 and the dorsal waist portion 30 respectively have the inclined elastic members (8a, 8b), but this is not limited thereto. At least one of the ventral waist portion 20 and the dorsal waist portion 30 is simply required to include the pair of inclined elastic members (8a or 8b). Even when the inclined elastic members (8a or 8b) are provided in one of the ventral waist portion 20 and the dorsal waist portion 30, the ability to pull up the diaper 1 during wearing operation can be improved as described above.

In the present embodiment, as shown in FIG. 2, in the vertical (longitudinal) direction, length L1 of the inclined portion 801b of each dorsal inclined elastic member 8b is longer than a length L2 of the inclined portion 801a of each ventral inclined elastic member 8a (L1>L2). Since the length (L1) of the inclined portion 801b of each dorsal inclined elastic member 8b is long, the pull-up force can be transmitted farther along the direction in which the dorsal inclined elastic members 8b extend, that is, can be transmitted further to the crotch side, when the pet's tail is passed through the tail insertion portion 50 to pull up the dorsal waist portion 30. As a result, at the time of wearing operation, the dorsal waist portion 30 side is more easily pulled up. In the present embodiment, three dorsal inclined elastic members 8b are arranged on the two lateral sides, respectively, but at least one of the three dorsal inclined elastic members 8b (that is, at least one pair of dorsal inclined elastic members 8a on the two lateral sides (one on each side)) is simply required to have the above-mentioned configuration.

As shown in FIG. 2, in the present embodiment, the dorsal inclined elastic members 8b span the longitudinal central position CL. Since the dorsal inclined elastic members 8b span the longitudinal central position CL, that is, since they extend to the ventral waist portion 20, the pull-up force acts in conjunction with the dorsal inclined elastic members 8b and is more easily transmitted to the ventral side when the diaper 1 is pulled up with the tail passed through the tail insertion portion 50. This can improve the fit on the ventral waist portion 20 side.

In the present embodiment, as shown in FIG. 2, in the longitudinal direction (vertical direction), a front end (lower end) 8be of each dorsal inclined elastic member 8b is located on the front side (lower side) with respect to a back end (upper end) 50up of the tail insertion portion 50. Since the front end (lower end) 8be of the dorsal inclined elastic member 8b is located in such a position, the dorsal inclined elastic members 8b work in conjunction to pull up the tail insertion portion 50 when the diaper 1 is pulled up with the tail passed through the tail insertion portion 50. This facilitates a better fit of the tail.

In the present embodiment, as shown in FIG. 2, in the longitudinal direction (vertical direction), the front end (lower end) 8be of each dorsal inclined elastic member 8b is located on the front side (lower side) with respect to a front end (lower end) 50dw of the tail insertion portion 50. That is, the dorsal inclined elastic members 8b extend completely beyond the tail insertion portion 50 in the longitudinal direction (vertical direction). By providing the dorsal inclined elastic members 8b in such a position, the dorsal inclined elastic members 8b work in conjunction to more easily pull up the tail insertion portion 50 when the diaper 1 is pulled up with the tail passed through the tail insertion portion 50. This improves the fit of the tail.

In the present embodiment, the dorsal inclined elastic members 8b span the longitudinal central position CL. Thus, in the diaper 1 in the underpants-shaped state of FIG. 1, the lower end of the dorsal inclined elastic member 8b in the vertical direction is located at a lower end of the diaper 1 (that is, corresponds to the longitudinal central position CL in FIG. 2). As described above, the lower end of each dorsal inclined elastic member 8b is located below the lower end 50dw of the tail insertion portion 50, thereby allowing the dorsal inclined elastic members 8b on the two lateral sides to work in conjunction to easily pull up the tail insertion portion 50.

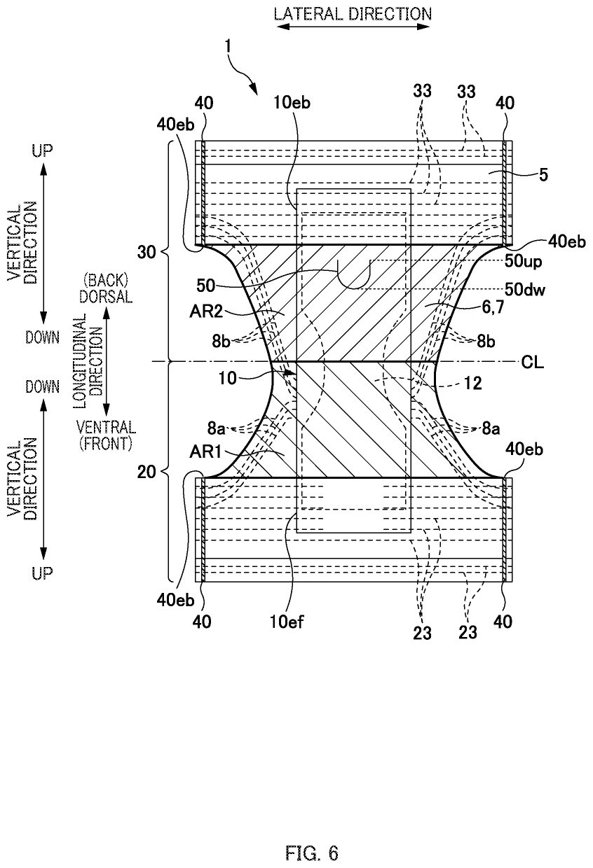

FIG. 6 illustrates the plan view of areas AR1 and AR2 in the diaper 1. In the present embodiment, as shown in FIG. 6, in the unfolded and stretched state, the area AR1 refers to an area of the diaper 1 from the longitudinal central position CL to a longitudinal inward end 40eb of each side-joining portion 40 of the ventral waist portion 20 (in FIG. 6, portions indicated by right-downward diagonal lines), and the area AR2 refers to an area of the diaper 1 from the longitudinal central position CL to a longitudinal inward end 40eb of each side-joining portion 40 of the dorsal waist portion 30. In this case, the area AR1 is smaller than the area AR2 (AR1<AR2). That is, in the diaper 1 of the present embodiment, the area on the ventral waist portion 20 is smaller. Since the area from the longitudinal central position CL of the diaper 1 to the longitudinal inward end (lower end) 40eb of the side-joining portion 40 of the ventral waist portion 20 is smaller, the pet's legs are less likely to get caught when putting the diaper 1 on the pet (specifically, when inserting the hind legs into the leg openings LH as shown in FIG. 5A). Such a configuration can reduce interference with movement of the legs not only at the time of wearing of the diaper 1, but also after the diaper 1 is put on.

Returning to FIG. 4, in the present embodiment, the dorsal waist portion 30 includes, at a position between the inclined portions 801b on the two lateral sides, the non-stretchy region 8bX where the dorsal inclined elastic members 8b cannot stretch and contract in the lateral direction. The tail insertion portion 50 and the non-stretchy region 8bX have an overlapping portion in the lateral direction. The non-stretchy region 8bX is the region where stretchability in the lateral direction is not exhibited. Thus, the overlapping portion where such a non-stretchy region 8bX and the tail insertion portion 50 overlap in the lateral direction can prevent the tail insertion portion 50 from deforming due to lateral contraction.

FIG. 7 illustrates a modification of the first embodiment. FIG. 7 illustrates the diaper 1 in the unfolded and stretched state as viewed from the non-skin side. The difference from the first embodiment described above is that the non-stretchy regions 8aX, 8bX are provided by cutting portions of the ventral and dorsal inclined elastic members 8a, 8b from the non-skin-side surface while fixing the ventral and dorsal inclined elastic members 8a, 8b with an adhesive. Specifically, in the modification, similar to the above-described embodiment, the ventral inclined elastic members 8a include straight portions 802a, 802a located along the lateral direction and between the inclined portions 801a, 801a on the two lateral sides. The dorsal inclined elastic members 8b also include straight portions 802b, 802b located along the lateral direction and between the inclined portions 801b, 801b on the two lateral sides. Then, the straight portions 802b, 802b on the dorsal side include a discontinuous portion 802bN in which the dorsal inclined elastic members 8b are discontinuous by being cut from the non-skin-side surface. Similarly, the straight portions 802a, 802a on the ventral side include a discontinuous portion 802aN in which the ventral inclined elastic members 8a are discontinuous by being cut from the non-skin-side surface. The discontinuous portion 802aN and the discontinuous portion 802bN respectively correspond to the non-stretchy regions 8aX and 8bX in the first embodiment, where the ventral and dorsal inclined elastic members 8a, 8b do not exhibit Stretchability in the lateral direction.

In the modification of FIG. 7, the absorbent core 12 does not exist in the region overlapping the tail insertion portion 50 in the thickness direction of the diaper 1 (see FIG. 3). That is, the tail insertion portion 50 is formed in the region 12NX where the absorbent core 12 does not exist. In the region 12NX, the non-skin-side surface of the skin-side core-wrapping sheet 17a located on the skin with respect to the absorbent core 12; and the skin-side surface Of the non-skin-side core-wrapping sheet 17b located on the non-skin side, are joined with a hot-melt adhesive or the like, such that the absorbent core 12 is not exposed from the tail insertion portion 50.

In the modification, the tail insertion portion 50 and the discontinuous portion 802bN do not overlap as viewed in the thickness direction. The discontinuous portion 802bN in the dorsal inclined elastic members 8b is a portion in which the dorsal inclined elastic members 8b are cut from the non-skin-side surface of the diaper 1, that is, from the non-skin side of the non-skin-side sheet 7 located farthest on the non-skin side. At the time of cutting of the dorsal inclined elastic members 8b in the state where the discontinuous portion 802bN and the tail insertion portion 50 overlap, portions of sheet members that constitute the tail insertion portion 50 (such as the non-skin-side sheet 7, the skin-side sheet 6, the back sheet 13, the core-wrapping sheet 17) may also be cut together, which may cause leakage from the tail insertion portion 50. The tail insertion portion 50 and the discontinuous portion 802bN do not overlap as viewed in the thickness direction, which can avoid such leakage.

In the modification shown in FIG. 7, the dorsal inclined elastic members 8b span the longitudinal central position CL, that is, the dorsal inclined elastic members 8b extend to the ventral waist portion 20. Therefore, also in the modification, leakage from the tail insertion portion 50 is avoided while the pull-up force is more easily transmitted to the ventral side during wearing operation of the diaper 1, thereby improving the fit on the ventral side. Due to the contractive force of the dorsal inclined elastic members 8b extending beyond the tail insertion portion 50 further to the ventral side, the whole of the dorsal inclined elastic members 8b works in conjunction to more easily pull up the tail insertion portion 50 when the diaper 1 is pulled up.

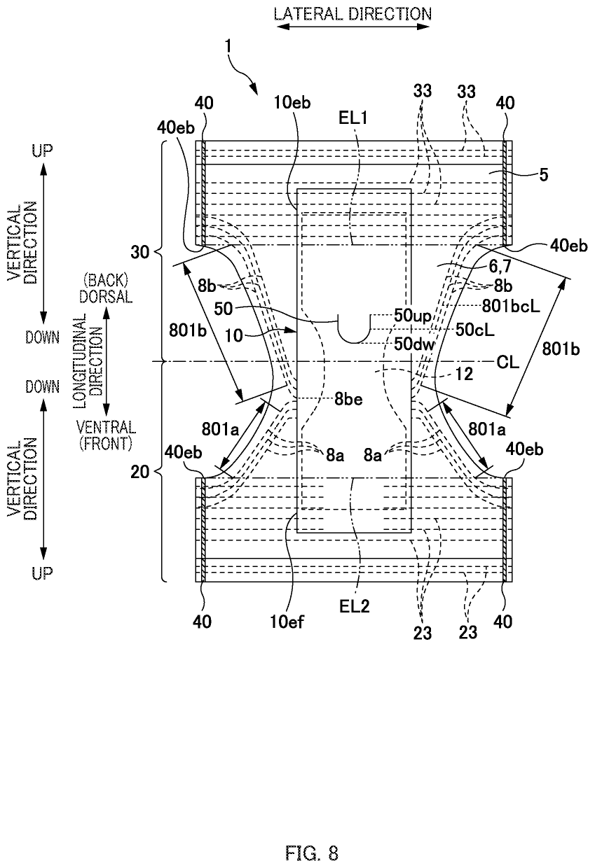

FIG. 8 illustrates a modification of arrangement of the tail insertion portion 50. As shown in FIG. 8, the tail insertion portion 50 of the modification is located on the lower side compare to the position of the tail insertion portion 50 of the above-described embodiment. Specifically, in the vertical direction, a central position 50cL of the tail insertion portion 50 is located below a central position 801bcL of the inclined portions 801b of the dorsal inclined elastic members 8b. As in the present modification, since the central position 50cL of the tail insertion portion 50 in the vertical direction is located below than the central position 801bcL of the inclined portion 801b, when the dorsal inclined elastic members 8b contract in the vertical direction at the time of wearing of the diaper 1, the upward pulling force from the dorsal inclined elastic members 8b is more likely to be applied to the tail insertion portion 50 located on the lower side. As a result, the tail insertion portion 50 is pulled up more easily. Thus, the tail insertion portion 50 is pulled up more easily to the base of the tail when the diaper 1 is pulled up at the end of wearing operation (see FIG. 5C), which can improve the fit of the tail.

As shown in FIG. 8, the tail insertion portion 50 in the modification is located below the tail insertion portion 50 in the above-described embodiment, but the front end (lower end) 8be of each dorsal inclined elastic member 8b in the longitudinal direction is located on the front side (lower side) with respect to the front end (lower end) 50dw of the tail insertion portion 50, as in the above-mentioned embodiment. That is, also in the present modification, the dorsal inclined elastic members 8b extend completely beyond the tail insertion portion 50 in the vertical direction. Therefore, when the diaper 1 is put on, the force for pulling the entire dorsal waist portion 30 upward is exerted by the dorsal inclined elastic members 8b arranged on the two lateral sides of the dorsal waist portion 30. Such a force allows the tail insertion portion 50 to be pulled up, thereby facilitating an improved fit of the tail.

### Second Embodiment

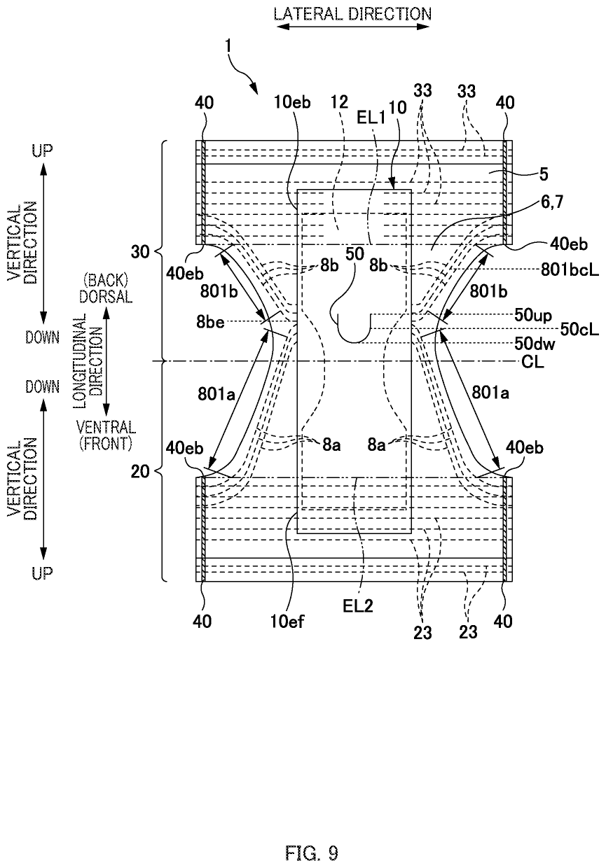

Next, an underpants-shaped disposable pet diaper 1 according to a second embodiment will be described with reference to FIG. 9. In the following description of the second embodiment, the same components as those in the first embodiment are denoted by the same reference numerals and therefore the detailed description thereof will be omitted. The diaper 1 according to the second embodiment differs in that, in the vertical direction (longitudinal direction), the length of the inclined portion 801a of each ventral inclined elastic member 8a is longer than the length of the inclined portion 801b of each dorsal inclined elastic member 8b. In the second embodiment, the ventral inclined elastic members 8a span the longitudinal central position CL, while the dorsal inclined elastic members 8b do not span the central position CL.

FIG. 9 is a schematic plan view of the diaper 1 in the unfolded and stretched state as viewed from the skin side, according to the second embodiment. As shown in FIG. 9, the diaper 1 of the second embodiment is located below the tail insertion portion 50 of the first embodiment. Specifically, in the vertical direction, the central position 50cL of the tail insertion portion 50 is located below the central position 801bcL of the inclined portion 801b of the dorsal inclined elastic members 8b. Since the central position 50cL of the tail insertion portion 50 in the vertical direction is located below the central position 801bcL of the inclined portion 801b, the pull-up force of the dorsal inclined elastic members 8b is more likely to be applied to the tail insertion portion 50 located on the lower side when the dorsal inclined elastic members 8b contract in the vertical direction at the time of wearing the diaper 1. Thus, the tail insertion portion 50 is pulled up more easily. As a result, when the diaper 1 is pulled up at the end of wearing operation (FIG. 5C), the tail insertion portion 50 is more easily pulled up to the base of the tail, which can improve the fit of the tail.

As described above, since the length of the inclined portion 801a of the ventral inclined elastic members 8a in the vertical direction (longitudinal direction) is long, the pull-up force can be transmitted farther along the direction in which the ventral inclined elastic members 8a extend, that is, further toward the crotch side. This can improve the ability to pull up the diaper 1 on the ventral waist portion 20 side at the time of wearing, and the fit on the ventral side can be improved.

The length of the inclined portion 801b of the dorsal inclined elastic members 8b in the second embodiment is shorter than that of the inclined portion 801b of the dorsal inclined elastic members 8b in the first embodiment, but in the vertical direction, the lower end 8be of each dorsal inclined elastic member 8b is located below the upper end 50up of the tail insertion portion 50. Thus, when the tail is passed through the tail insertion portion 50 and the diaper 1 is pulled up, the dorsal inclined elastic members 8b work in conjunction to pull up the tail insertion portion 50, which facilitates a better fit of the tail.

### Others

The above-mentioned embodiments have been described in order to facilitate the understanding of the present disclosure, not to interpret the present disclosure in a limited manner. The present disclosure may variously be changed or altered without departing from its gist and encompass equivalents thereof.

In the above-described first and second embodiments, the dorsal inclined elastic members 8b or ventral inclined elastic members 8a span the longitudinal central position CL of the diaper 1 in the unfolded and stretched state, but this is not limited thereto. The dorsal inclined elastic members 8b and the ventral inclined elastic members 8a need not span the longitudinal central position CL of the diaper 1. In particular, in the first embodiment, as long as the lower end 8be of each dorsal inclined elastic member 8b is located below the lower end 50dw of the tail insertion portion 50, the dorsal inclined elastic members 8b work in conjunction to pull up the tail insertion portion 50 when the diaper 1 is pulled up at the end of wearing operation (see FIG. 5C), which facilitates a better fit of the diaper 1 to the base of the tail.

The position of the tail insertion portion 50 in the diaper 1 of the second embodiment is merely an example, and is not limited thereto. For example, tail insertion portion 50 may be located above the position of the tail insertion portion 50 shown in FIG. 9. Specifically, the lower end 50dw of the tail insertion portion 50 may be located above the lower end of each dorsal inclined elastic member 8b.

### REFERENCE SIGNS LIST

1: underpants-shaped disposable pet diaper (diaper)
5: exterior body
6: skin-side sheet
7: non-skin-side sheet
8a: ventral inclined elastic member (inclined elastic member)
8aX: non-stretchy region
8b: dorsal inclined elastic member (inclined elastic member)
8be: front end (lower end)
8bX: non-stretchy region
10: absorbent main body
10eb: end portion
10ef: end portion
11: top sheet
12: absorbent core
12NX: region where core does not exist
13: back sheet
17: core-wrapping sheet
17b: dorsal core-wrapping sheet
20: ventral waist portion
23: ventral elastic member
30: dorsal waist portion
33: dorsal elastic member
40: side-joining portion
40eb: inward end (lower end)
50: tail insertion portion
50cL: central position
50dw: front end (lower end)
50up: back end (upper end)
801a: inclined portion
801b: inclined portion
801bcL: central position
802a: straight portion
802aN: discontinuous portion
802b: straight portion
802bN: discontinuous portion

1. An underpants-shaped disposable pet diaper having a vertical direction and a lateral direction that intersect with each other, the underpants-shaped disposable pet diaper comprising:
an absorbent main body including an absorbent core;
a ventral waist portion; and
a dorsal waist portion,
two lateral side portions of the ventral waist portion and two lateral side portions of the dorsal waist portion being joined by a pair of side-joining portions,
a tail insertion portion through which a tail is passed being provided below the pair of side-joining portions in the vertical direction,
at least one of the ventral waist portion and the dorsal waist portion including a pair of inclined elastic members,
the pair of inclined elastic members each having an inclined portion,
the inclined portion being located below the pair of side-joining portions in the vertical direction and at two lateral side portions,
the inclined portion extending inward in the lateral direction and diagonally downward in the vertical direction.

2. The underpants-shaped disposable pet diaper according to claim 1, wherein in an unfolded and stretched state,
an area of the underpants-shaped disposable pet diaper from a longitudinal central position of the underpants-shaped disposable pet diaper to a longitudinal inward end of the side-joining portion of the ventral waist portion
is smaller than
an area of the underpants-shaped disposable pet diaper from the longitudinal central position to a longitudinal inward end of the side-joining portion of the dorsal waist portion.

3. The underpants-shaped disposable pet diaper according to claim 1, wherein
the pair of inclined elastic members is arranged in the ventral waist portion and the dorsal waist portion, respectively,
the inclined elastic member of the ventral waist portion refers to a ventral inclined elastic member,
the inclined elastic member of the dorsal waist portion refers to a dorsal inclined elastic member, and
in the vertical direction, a length of the inclined portion of the dorsal inclined elastic member is longer than a length of the inclined portion of the ventral inclined elastic member.

4. The underpants-shaped disposable pet diaper according to claim 1, wherein
the pair of inclined elastic members is arranged in the dorsal waist portion, and
the pair of inclined elastic members is arranged to span a longitudinal central position of the underpants-shaped disposable pet diaper in an unfolded and stretched state.

5. The underpants-shaped disposable pet diaper according to claim 1, wherein
the pair of inclined elastic members is arranged in the dorsal waist portion, and
in the vertical direction, a lower end of each of the inclined elastic members is located below an upper end of the tail insertion portion.

6. The underpants-shaped disposable pet diaper according to claim 1, wherein
the pair of inclined elastic members is arranged in the dorsal waist portion, and
in the vertical direction, a lower end of the inclined elastic member is located below a lower end of the tail insertion portion.

7. The underpants-shaped disposable pet diaper according to claim 1, wherein
the pair of inclined elastic members is arranged in the dorsal waist portion,
the dorsal waist portion includes a non-stretchy region between a pair of the inclined portions of the pair of inclined elastic members,
the non-stretchy region being a region where the inclined elastic members are not capable of stretching and contracting in the lateral direction, and
the tail insertion portion and the non-stretchy region have an overlapping portion in the lateral direction.

8. The underpants-shaped disposable pet diaper according to claim 1, wherein
the pair of inclined elastic members is arranged in the dorsal waist portion,
the pair of inclined elastic members has a straight portion that is located along the lateral direction and between a pair of the inclined portions,
the straight portion has a discontinuous portion in which the inclined elastic members are discontinuous by being cut from a non-skin-side surface,
the absorbent core does not exist in a region overlapping the tail insertion portion in a thickness direction of the underpants-shaped disposable pet diaper, and
the tail insertion portion and the discontinuous portion do not overlap as viewed in the thickness direction.

9. The underpants-shaped disposable pet diaper according to claim 8, wherein
the pair of inclined elastic members is arranged to span a longitudinal central position of the underpants-shaped disposable pet diaper in an unfolded and stretched state.

10. The underpants-shaped disposable pet diaper according to claim 1 wherein
the pair of inclined elastic members is arranged in the dorsal waist portion, and
in the vertical direction, a central position of the tail insertion portion is located below a central position of the inclined portion.
